(19) United States
(12) Patent Application Publication
(10) Pub. No.: US 2005/0058572 A1
(43) Pub. Date: Mar. 17, 2005

(54) Hypergolic fuel analytical device

(75) Inventor: Timothee Pourpoint, West Lafayette, IN (US)

Correspondence Address: TOWNSEND & BANTA, 601 PENNSYLVANIA AVE N.W., SUITE 900, SOUTH BLDG, WASHINGTON, DC, 20004, US

(73) Assignee: Swift Enterprises, Ltd.

(21) Appl. No.: 10/660,631

(22) Filed: Sep. 12, 2003

(51) Int. Cl. G01N 1/00

(52) U.S. Cl. 422/50

(57) ABSTRACT

A hypergolic fuel analytical device is provided for testing the reactive characteristics of hypergolic substances. An oxidizer and a reactive fuel/substance are atomized and mixed under pressurized gas force, and the reaction characteristics thereof measured for analysis. The hypergolic fuel analytical device comprises a compressed inert gas supply means; a first valve flowably connected to the inert gas means; a reservoir flowably connected to the first valve; a second valve flowably connected to the reservoir; a switching means conductively connected to the first valve and the second valve; a gas conduction means connected to the second valve, the gas conduction means having a first gas lead and a second gas lead; an oxidizer atomization means connected to the first gas lead; a fuel atomization means connected to the second gas lead; an oxidizer supply means flowably connected to the oxidizer atomization means; and a fuel supply means flowably connected to the fuel atomization means, wherein fuel is fed from the fuel supply means into said fuel atomization means, oxidizer is fed from the oxidizer supply means into said oxidizer atomization means, the switching means activates the first valve so as to open said first valve and fill the reservoir with compressed inert gas, and the switching means then activates the second valve so as to open same and thus feed compressed inert gas from the second valve to the oxidizer atomization means and the fuel atomization means via the first gas lead and the second gas lead.

### FIELD OF THE INVENTION

The present invention provides a hypergolic fuel analytical device. More specifically, a testing device to test the reactive characteristics of hypergolic substances is provided, wherein an oxidizer and reactive fuel/substance are atomized and mixed under pressured gas force, and the reaction characteristics thereof measured for analysis.

### BACKGROUND OF THE INVENTION

Hypergolic fuels are substances which, when exposed to an oxidizer, ignite relatively spontaneously without the need of an ignition source. Traditionally, hypergolic fuels have been used in rocket engines, boosters, missiles, etc. In order to determine which substances are useful as a hypergolic fuel, various characteristics thereof must first be determined. In particular, the ignition delay characteristics of certain hypergolic substances, and combinations of hypergolic substances with oxidizers, must be tested so as to determine the suitability of the substance for use as a hypergolic fuel in a rocket engine.

Conventionally, drop test devices have been used to test hypergolic fuels. With such drop test devices, the oxidizer is usually loaded in a drop generator type device (such as a 100 micro-liter syringe, or a very small burette) while a few drops of fuel are placed in a container placed on a support plate. The oxidizer is then dropped into the fuel, and ignition delay measured.

Ignition delay can then be measured in different ways. One common way to measure ignition delay is through the use of a motion sensor and a photodiode connected to an oscilloscope. For example, as an oxidizer drop hits the crucible and ignites the fuel, the oscilloscope successively picks up the vibration of the crucible from the oxidizer drop hitting the crucible and the light emission from the ignition event. These two signals can be sent to two distinct oscilloscope channels and ignition delay is read directly on the oscilloscope screen.

Prior to running another test, the fuel crucible needs to be replaced. The oxidizer micro-liter syringe also needs to be refilled every two to three tests depending upon its internal volume. The fuel crucible and the oxidizer syringe are usually refilled manually.

Due to the frequency of the reloads, and in order to avoid any accidental contact between the oxidizer and the fuel, two experimenters are needed to perform ignition delay measurements with a drop test device. Furthermore, drop tests devices cannot be remotely triggered. Both experimenters, therefore, have to extra precautions when testing a fuel for which the ignition event “strength” is unknown.

As experienced by users of drop test devices, the cleanliness of the photodiode plays an important role in a test series, as combustion gases deposit on the photodiode and tend to block out the light from the ignition event. It is therefore important to frequently clean the photodiode. The previously mentioned operations usually take a few minutes to perform leading to a relatively slow test rate, e.g., 30 to 50 tests an hour may be performed by two experimenters working together using such a drop test device. The slow test rate inherent to drop devices is of particular importance when performing many tests, as the test repeatability tends to degrade significantly as the test conditions change (room temperature or humidity) and the photodiode gets dirtier.

Issues related to the cleanliness of the photodiode can be avoided by using a high speed video camera to record the ignition event and later derive the ignition delay. However, while high speed video cameras provide a convenient means of measuring ignition delay, their inherent characteristics (internal memory mainly) facilitate the recording of a continuous chain of events rather than a discrete chain of events.

Finally, when using a drop test device, propellants are not atomized, as they would be in a rocket engine injector. In most cases, this leads to ignition delay values much higher those recorded during actual test firings. As an example, when recorded with a drop test device, ignition delay values of a hypergolic fuel developed by the US Navy (Block 0) average around 9 milliseconds, while ignition delay of the same fuel in a rocket engine has been shown to be around 3 milliseconds. The discrepancy between these two values strongly depends on the type of fuel tested, and cannot be theoretically derived.

A two-jet apparatus has been proposed for measurement of ignition delays of hypergolic rocket propellants was previously proposed by Spengler, et al. in a paper entitled “Measurements of Ignition Delays Of Hypergolic Liquid Rocket Propellants”. In the apparatus disclosed therein, unlike the present invention, a liquid is pressurized within an injector unit and released via capillary tubes as a liquid jet into a combustion chamber by opening an oxidizer-side valve and a fuel-side valve in a precise sequence. The droplets of oxidizer and fuel are created by the transformation of the jets kinetic energy into a shear force that breaks the atomic bonds of the liquid jets. Further, each of the above mentioned valves, unlike the present invention, is magnetic, and the duration of the injection must be controlled by precisely opening and closing the valves.

The two-jet apparatus has certain drawbacks. Namely, measurement of combustion events with such apparatus becomes inaccurate as the speed of measurement increases, i.e., timing problems occur with the operation of the valves, no variation in injection angle is possible, relatively high pressure must be maintained in order to get good droplet distribution, and a precise alignment of the two injectors is necessary in order for the streams of oxidizer and fuel emanating from the apparatus to impinge on each other. Most of the breakup occurs when the jets impinge on each other thus reducing their kinetic energy to zero.

Further, if the user wishes to measure a series of combustions in relative succession, fast response valves are needed to attain any sort of accuracy whatsoever, which increases the complexity and cost, and decreases the reliability of the device. In addition, the two-jet apparatus ejects the propellant in relatively large droplet form. In such form, complete combustion is unlikely, leading to a high measuring error (standard deviation).

It is an object of the present invention to provide a hypergolic fuel analytical device which overcomes the problems of the conventional devices, such as described above. Specifically, it is an object of the present invention to provide a device for testing hypergolic fuels and oxidizers, wherein the fuel and atomizer are atomized (as in the true applications thereof). In atomizing the propellants, it is an object of the present invention to provide an apparatus which can measure ignition delay values much closer to the test fire conditions ignition delay values.

Further, it is an object of the present invention to provide a device which may provide a more continuous chain of events (ignitions) than the conventional test devices, so as to efficiently utilize a high speed camera in measuring a chain of hypergolic ignitions.

### SUMMARY OF THE INVENTION

In order to achieve the object of the present invention described above, in a first embodiment of the present invention, a hypergolic fuel analytical device is provided comprising:
a compressed inert gas supply means;
a first valve flowably connected to said inert gas means;
a reservoir flowably connected to said first valve;
a second valve flowably connected to said reservoir;
a switching means conductively connected to said first valve and said second valve;
a gas conduction means connected to said second valve, said gas conduction means having a first gas lead and a second gas lead;
an oxidizer atomization means connected to said first gas lead;
a fuel atomization means connected to said second gas lead;
an oxidizer supply means flowably connected to said oxidizer atomization means; and
a fuel supply means flowably connected to said fuel atomization means,
wherein fuel is fed from the fuel supply means into said fuel atomization means, oxidizer is fed from the oxidizer supply means into said oxidizer atomization means, the switching means activates the first valve so as to open said first valve and fill the reservoir with compressed inert gas, and the switching means then activates the second valve so as to open same and thus feed compressed inert gas from the second valve to the oxidizer atomization means and the fuel atomization means via the first gas lead and the second gas lead.

In a second embodiment of the present invention, the hypergolic fuel analytical device of the first embodiment above is provided, further comprising:
a fuel atomization means adjustment apparatus adjustably connected with said fuel atomization means, and
an oxidizer atomization means adjustment apparatus adjustably connected with said oxidizer atomization means.

In a third embodiment of the present invention, the hypergolic fuel analytical device of the first embodiment above is provided, further comprising an ignition detection means.

In a fourth embodiment of the present invention, the hypergolic fuel analytical device of the first embodiment above is provided, further comprising a programmable computer control means electrically connected to the switching means, wherein testing operation of the device may be controlled thereby.

In a fifth embodiment of the present invention, the hypergolic fuel analytical device of the first embodiment above is provided, further comprising a containment means adjacent the fuel atomization means and oxidizer atomization means, for containment of hypergolic reactions.

In a sixth embodiment of the present invention, the hypergolic fuel analytical device of the first embodiment above is provided, further comprising:
a fuel supply control means in flowable connection with the fuel supply means and the fuel atomization means, which controls the supply of fuel fed to the fuel atomization means; and
an oxidizer supply control means in flowable connection with the oxidizer supply means, which controls the supply of fuel fed to the oxidizer atomization means.

In a seventh embodiment of the present invention, the hypergolic fuel analytical device of the fourth embodiment above is provided, further comprising:
a fuel supply control means in flowable connection with the fuel supply means and the fuel atomization means, which controls the supply of fuel fed to the fuel atomization means; and
an oxidizer supply control means in flowable connection with the oxidizer supply means, which controls the supply of fuel fed to the oxidizer atomization means,
wherein the programmable computer control is in electrical connection with the fuel supply control means and oxidizer supply control means, so as to control the supply of fuel and oxidizer fed to the fuel atomization means and the oxidizer atomization means from the fuel supply means and oxidizer supply means.

In an eighth embodiment of the present invention, the hypergolic fuel analytical device of the first embodiment above is provided, further comprising a third valve flowably connected to said second valve, and said gas conduction means connected to said third valve opposite said second valve.

In a ninth embodiment of the present invention, a hypergolic fuel analytical device is provided comprising:
a compressed inert gas supply means;
a fast-action valve flowably connected to said inert gas means;
a switching means conductively connected to said fast-action;
a gas conduction means connected to said second valve, said gas conduction means having a first gas lead and a second gas lead;
an oxidizer atomization means connected to said first gas lead;
a fuel atomization means connected to said second gas lead;
an oxidizer supply means flowably connected to said oxidizer atomization means; and
a fuel supply means flowably connected to said fuel atomization means,
wherein fuel is fed from the fuel supply means into said fuel atomization means, oxidizer is fed from the oxidizer supply means into said oxidizer atomization means, the switching means activates the fast-action valve so as to open said fast-action valve and thus feed compressed inert gas from the fast-action valve to the oxidizer atomization means and the fuel atomization means via the first gas lead and the second gas lead.

### BRIEF DESCRIPTION OF THE DRAWINGS

FIG. 1 is a perspective view of the hypergolic fuel analytical device of the first and second embodiment of the present invention.

FIG. 2 is a top view of the hypergolic fuel analytical device of the first and second embodiment of the present invention, illustrating the operational stage of the device in which the sprayed hypergolic fuel and oxidizer intersect and react.

FIG. 3 is a perspective view of the hypergolic fuel analytical device of the present invention, as shown in FIG. 1, further illustrating the video recording ignition detection means of the third embodiment herein.

FIG. 4 is a top view of the hypergolic fuel analytical device of the seventh embodiment of the present invention, illustrating the provision of a plurality of fuel and oxidizer supply means, in flowable connection with the fuel atomization means and oxidizer atomization means, respectively, via variable valves.

FIG. 5 is a perspective view of the hypergolic fuel analytical device of the present invention, illustrating the containment means for containing the ignition of the fuel and oxidizer, and ignition detection means, as provided in the third and fifth embodiments herein.

FIG. 6 is a top view of the hypergolic fuel analytical device of the present invention, illustrating the eighth embodiment of the present invention, wherein two valves (a second and third valve) are provided to control the release of the compressed inert gas flow to the reservoirs.

FIG. 7 is a top view of the hypergolic fuel analytical device of the present invention, illustrating the ninth embodiment of the present invention, wherein a single fast-action valve is provided, to control the release of the compressed inert gas flow to the reservoirs.

FIG. 8 is a graph illustrating the differences in ignition delay values obtained when testing a hypergolic fuel and an oxidizer using the hypergolic fuel analytical device of the present invention versus a conventional two-jets apparatus and a conventional drop test device.

FIG. 9 is a graph illustrating the test frequency capable of being achieved with the hypergolic fuel analytical device of the present invention versus a conventional two-jets apparatus and a drop test device.

FIG. 10 is a graph illustrating the test repeatability of the hypergolic fuel analytical device of the present invention versus a conventional two-jets apparatus and a drop test device.

FIGS. 11a-11d are high speed photographs of the hypergolic reaction of Block 0 (22% manganese acetate tetrahydrate in methanol solution (w/w)) and 97% hydrogen peroxide, as described in Test Example 1.

FIGS. 12a-12f are high speed photographs of the hypergolic reaction of Block 0 and 97% hydrogen peroxide, as described in Comparative Test Example 1.

### DETAILED DESCRIPTION OF THE INVENTION

The hypergolic fuel analytical device of the present invention comprises atomizing nozzles to disperse separate liquid streams of oxidizer and hypergolic fuel into droplets. These droplets form two sprays that cross each other and react. The Two-Jets Apparatus uses capillary tubes to inject liquid jets into a combustion chamber. The droplets are created by the transformation of the jets kinetic energy into a shear force that breaks the atomic bonds of the liquid jets.

The sprays generated with the device of the present invention can be defined as aerosols; mixtures of air and dispersed liquid (whereas jets, such as are created with conventional devices, are purely liquid). Aerosols are more beneficial than jets in measuring ignition delay because they enhance mass transfer and mass distribution. Mass transfer is improved, thanks to the transformation of a liquid into a vapor. Mass distribution is enhanced because the liquid/vapor is spatially spread throughout the region of interest.

In the case of hypergolic propellants, the improved mass transfer and mass distribution provided by the aerosols (sprays) allow for the liquids of interest to react with each other immediately after contact. All of the kinetic energy imparted to the liquids is used to get droplets to hit (impinge upon) each other with the highest efficiency possible. In contrast, when jets impinge on each other, part of the kinetic energy imparted to the liquids is used to break up the jets into droplets. The droplets then “use” the remaining kinetic energy to travel and impinge on each other.

Thus, the pressure required to get a good droplet distribution (large number of small droplets) is much lower with the hypergolic fuel analytical device of the present invention than it would be with any apparatus using the impingement of two-jets to created droplets. For example, the present device has been shown to provide repeatable results with pressures as low as 15 psig, whereas a conventional two-jets device may require as much as 50 psig of pressure to achieve reasonable jet breakup.

Further, the pressures required by a two-jets device are more dependent on mass flow rate and orifice diameter than with the present invention. In addition, the improved mass transfer and mass distribution provided by aerosols lead to faster mixing in turn leading to faster ignition and better test reproducibility.

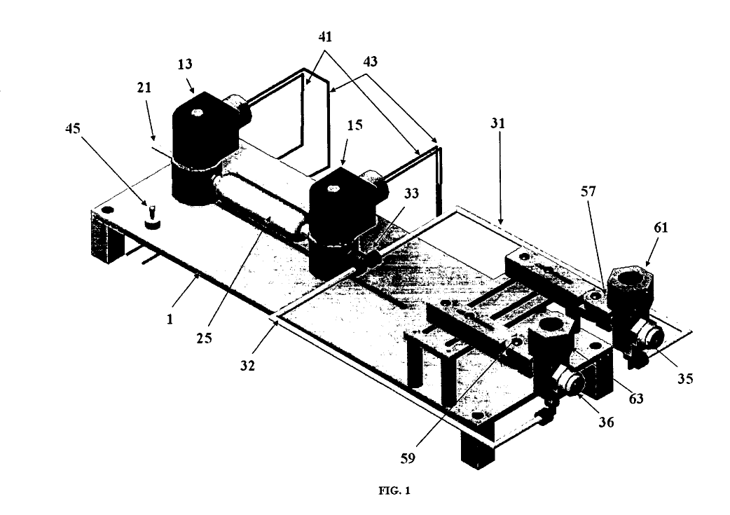

In the first embodiment of the present invention, as illustrated in FIG. 1, a hypergolic fuel analytical device is provided having a compressed inert gas supply means 1, a first valve 13 flowably connected to the inert gas supply means 1 via compressed gas supply line 21, and a reservoir 25 flowably connected to the first valve 13. A second valve 15 is flowably connected to the reservoir 25, a switching means 45 is conductively connected to the first valve 13 and the second valve 15 via electrical leads 41 and 43. A gas conduction means 33 is connected to the second valve 15, the gas conduction means 33 having a first gas lead 31 and a second gas lead 32.

An oxidizer atomization means 35 is flowably connected to the first gas lead 31, and a fuel atomization means 36 is flowably connected to the second gas lead 32. An oxidizer supply means 61 is flowably connected to the oxidizer atomization means 35, and a fuel supply means 63 is flowably connected to the fuel atomization means 36.

In the structure described above, when desiring to test the performance characteristics of a hypergolic fuel, fuel is fed from the fuel supply means 63 into the fuel atomization means 36, and oxidizer is fed from the oxidizer supply means 61 into the oxidizer atomization means 35. The switching means 45 then, or simultaneously, activates the first valve 13, so as to open the first valve 13 and fill the reservoir 25 with compressed inert gas. The switching means 45 may then activate the second valve 15, so as to open same. This action acts to release the compressed inert gas from the second valve 15 into the oxidizer atomization means 35 and the fuel atomization means 36, via the first gas lead 31 and the second gas lead 32.

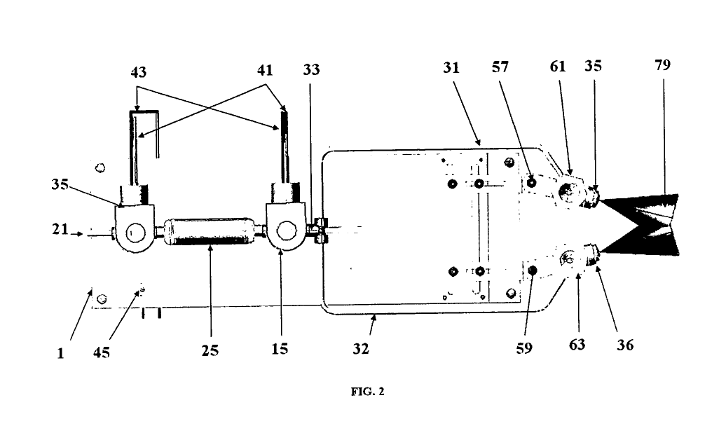

The simultaneous rush of the compressed inert gas through the fuel atomization means 36 and the oxidizer atomization means 35 acts to spray the hypergolic fuel and the oxidizer into a predetermined intersecting spray pattern 79, as shown in FIG. 2. The fuel atomization means 36 may be provided with a fuel atomization means adjustment apparatus 59, wherein the fuel atomization means adjustment apparatus 59 is adjustably connected with the fuel atomization means 36. For example, as shown in FIG. 1, the fuel atomization means 36 may consist of an air atomizing nozzle, and the fuel atomization means adjustment apparatus 59 may consist of adjustable arms or joints upon which the air atomization nozzle is removably or permanently mounted.

The oxidizer atomization means 35 likewise may be provided with an oxidizer atomization adjustment apparatus, wherein the oxidizer atomization means 35 is adjustably connected with the oxidizer atomization means adjustment apparatus 57. For example, as shown in FIG. 1, the oxidizer atomization means 35 may consist of an air atomizing nozzle, and the oxidizer atomization means adjustment apparatus 57 may consist of adjustable arms or joints upon which the air atomization nozzle is removably or permanently mounted.

In testing the ignition characteristics of a fuel or oxidizer, adjustment of the angle of intersection of the two components may produce varying ignition test results. The fuel atomization means adjustment apparatus 59 and the oxidizer atomization means adjustment apparatus 57 allows a user of the device to control the flow pattern of the fuel and oxidizer, i.e., the intersection angle of the fuel and oxidizer. Thus, various flow patterns may be tested, so as to determine the most desirable flow pattern.

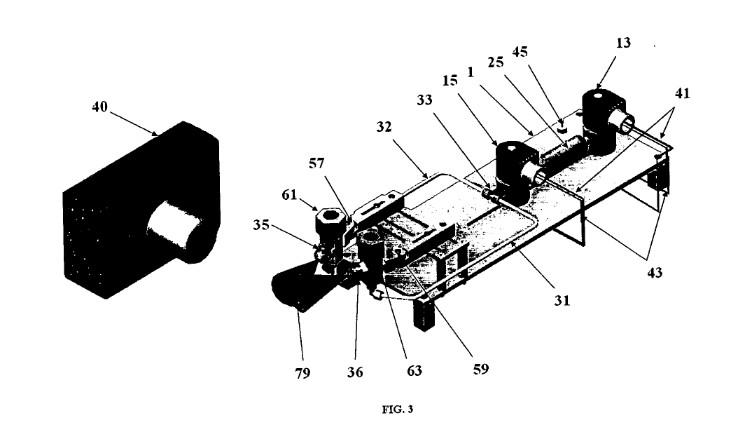

Hypergolic fuel ignition processes occur in sub-second intervals. As such, to accurately record the ignition characteristics of a hypergolic fuel, the ignition thereof with an oxidizer must be electronically observed using recording equipment. The present invention provides an ignition detection means 40, as illustrated in FIG. 3, to monitor the hypergolic ignition process. Such ignition detection means 40 generally includes video recording equipment capable of very fast recording periods, such as 1/10000 of a second shutter speeds and faster.

The ignition detection means 40 may optionally include detection means such as heat, energy and light detection means. The data produced by the ignition detection means 40 may be used to compute, for example, the ignition delay inherent in a particular hypergolic fuel/oxidizer mixture. Such data is very important in the determination of the usefulness of such a component combination in highly specific applications, such as rocketry.

In a further embodiment, the hypergolic fuel analytical device of the present invention may comprise a programmable computer control means for controlling the operation of the device. Such a computer control means (not illustrated in the Figures herein) is electrically connected to the switching means 45, so as to be capable of controlling the input and output of compressed gas into the device system via the control of the first valve 13 and the second valve 15. Such automation of the device may enable repeated, extremely quick testing of a hypergolic fuel, much faster than is humanly possible.

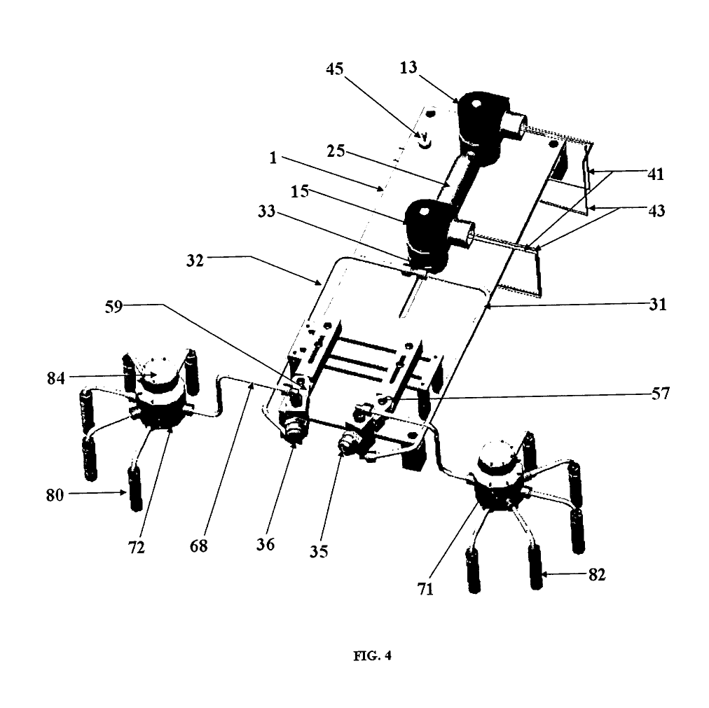

In a sixth embodiment of the present invention, as shown in FIG. 4, the hypergolic fuel analytical device of the present invention further contains a fuel supply control means 72 in flowable connection with the fuel supply means 63 and the fuel atomization means 36 via fuel supply line 68, the fuel supply control means 72 controlling the supply of fuel fed to the fuel atomization means 36. For example, the fuel supply means 63 may be alternatively located remotely from the fuel atomization means 36, and a computer-controlled electric fuel pump acting as a fuel supply control means 72 may be flowably connected to both the fuel supply 63 and fuel atomization means 36. The fuel supply control means may then precisely and reliably supply fuel, as desired, to the fuel atomization means 36. Further, the fuel supply control means 72 may be flowably connected to one or more fuel supplies 80, so as provide the user of the device of the present invention with the capability of testing one or more different types of fuels as desired

Likewise, an oxidizer supply control means 71 may be provided in flowable connection with the oxidizer supply means 61 and the oxidizer atomization means 35, so as to control the supply of oxidizer fed to the oxidizer atomization means. As with the fuel supply control means 72, the oxidizer supply control means 71 may be in flowable connection with one or more oxidizer supplies 82, so as provide the user of the device of the present invention with the capability of testing one or more different types of oxidizers as desired.

To further automate the process, as well as providing higher repeatability, the programmable computer control means mentioned above may be electrically connected with the fuel supply control means 72 and the oxidizer supply control means 71, so as to control the supply of fuel and oxidizer fed to the fuel atomization means 36 and the oxidizer atomization means 35 from the fuel supply means 63 and oxidizer supply means 61, as well as allowing the user to preselect which type of fuel and/or oxidizer to test, in which order to test the combinations, the speed of testing, etc.

Thus, a user of the device of the present invention can control the switching means 45, the fuel supply control means 72, the oxidizer supply control means 71 and the ignition detection means 40 via the programmable computer control means, thereby automating the entire testing process of a hypergolic fuel. Such control is achieved by electrically connecting the computer control means, such as a personal computer, with the switching means 45 (such as an electrical switch), the fuel supply control means 72 (such as an electric pump), the oxidizer supply control means 71 (such as an electric pump), and an ignition detection means 40 (such as a video camera).

The programmable computer control means is then, for example, programmed to, in a first step, feed a specified amount of fuel and oxidizer to the fuel atomization means 36 and oxidizer atomization means 35, in a second step, to pressurize the reservoir 25 via the first valve 13 and switching means 45, in a third step, to open the second valve 15 via the switching means 45, thus spraying the fuel and oxidizer into contact with each other and, in a fourth step, to simultaneously activate the ignition detection means 40 (such as a video camera) to record the ignition process.

Unlike conventional techniques and devices, the device of the present invention can provide for repeated testing in an extremely fast manner, as the device needs no cleaning between tests. Further, if desired, in a further embodiment of the present invention, as shown in FIG. 4, various fuel supplies and/or oxidizer supplies may be connected to the fuel atomization means 36 and oxidizer atomization means 35, so as to selectively test various combinations of fuels and oxidizers. In such an embodiment, a variable valve 84 is contained in the fuel supply control means 72 and/or the oxidizer supply control means 71, or between same and the fuel atomization means 36, so as selectively flowably provide fuel and/or oxidizer to the fuel atomization means 36 and the oxidizer atomization means 35.

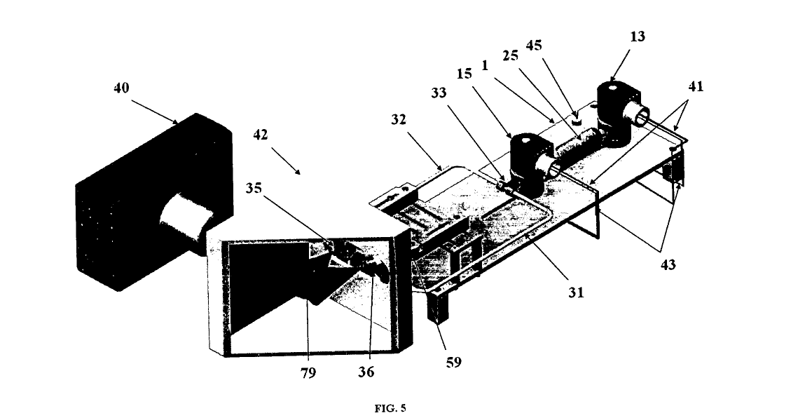

As described in the fifth embodiment of the present invention, and as illustrated in FIG. 5 herein, the hypergolic fuel analytical device of the first embodiment above may be provided with a containment means 42 adjacent the fuel atomization means and oxidizer atomization means, for containment of hypergolic reactions. Such containment means 42 may comprise a partially or wholly closed, non-flammable container. Preferably, the container is either clear, so that the ignition detection means may clearly record the ignition process, or is provided with an entry port for insertion of the ignition detection means. Further, the size of the containment means 42 is to be selected so as not to interfere with the spray pattern, i.e., the angle of interaction, of the fuel and oxidizer.

Thus, the present invention provides a device capable of quickly and repeatedly testing the ignition of a hypergolic fuel and oxidizer. In contrast, whereas the conventional two-jet apparatus utilizes two magnetic valves to inject two ignition components, the present invention utilizes a simpler, more precise and more reliable system having at least one electronically controlled valve to inject pressurized gas into the fuel and oxidizer so as to atomize same, repeat such test repeatedly in a short period of time, and record and analyze the results of such tests, thus achieving the unexpected results found herewith.

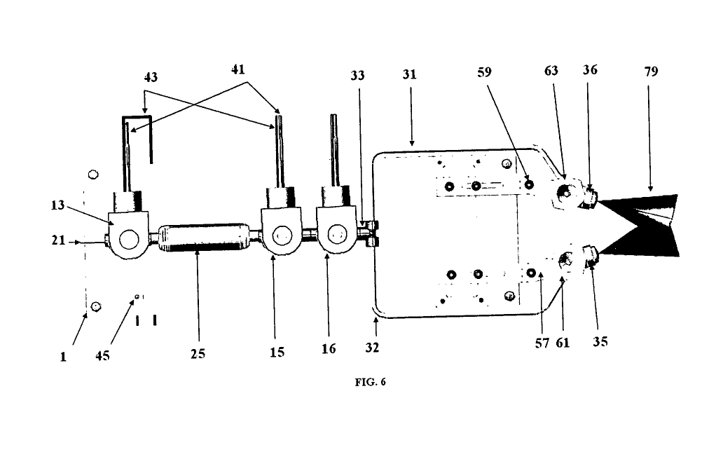

However, the present invention may, as shown in FIG. 6 herein, utilize two electronically controlled valves (i.e., second valve 15 and third valve 16) to more precisely control the volume of the injected liquid. In particular, in an eighth embodiment of the present invention, a third valve 16 is flowably connected to said second valve 15 via compressed gas line 34, flowably connected to the gas conduction means 33, and conductively connected to the switching means 45. The provision of the additional third valve 16 serves to enable more accurate measurement of the volume of inert compressed gas released to atomize the fuel and oxidizer, thus providing more accurate and reliable testing.

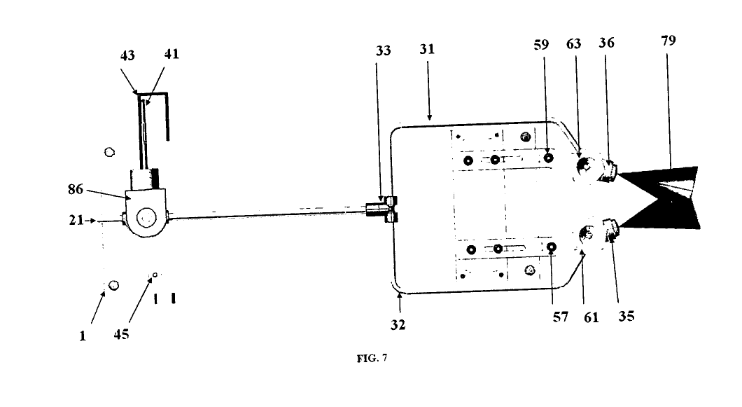

In a further ninth embodiment of the present invention, as shown in FIG. 7 herein, a single valve system is provided, comprising a single fast-action valve 86. The single, electrically activated fast-action valve 86 is flowably connected to the inert gas supply means 1 via the compressed gas supply line 21, conductively connected to the switching means 45, and flowably connected to the gas conduction means 33. In this structure, unlike with the conventional two-jet apparatus, the present invention atomizes the fuel and oxidizer, such that the ignition each time is almost complete, and provides a high level of reliability and repeatability due to the utilization of a single fast-action valve system to control compressed gas flow to the atomizing components.

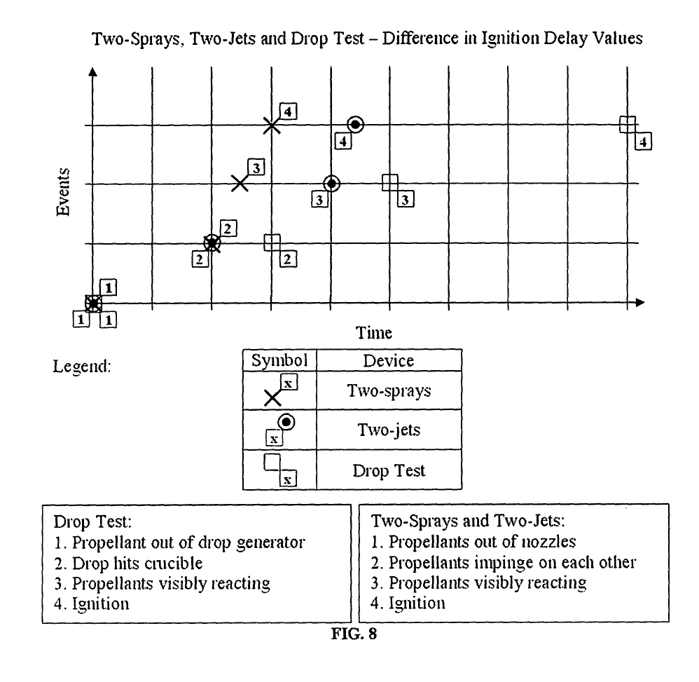

The processes leading to ignition of a hypergolic fuel and an oxidizer are, generally, the injection of propellants (hypergolic fuel and an oxidizer) from the device, the impingement of the propellants (contact with each other), the visible reaction of the propellants, and the ignition of the propellants, as graphically illustrated in FIG. 8. As illustrated therein, the hypergolic fuel analytical device of the present invention provides a much shorter ignition delay than the conventional drop test device and the two-jet apparatus.

Specifically, as shown in FIG. 8, the processes leading to ignition are divided into 4 steps:

1. Define as time=0, the first step corresponds to the time at which the propellants are ejected from their container. In the case of the drop-test, only one propellant is set in motion at that time. In the case of a two-sprays or two-jets device, all propellants are set in motion at that time (i.e., time=0).

2. The second step corresponds to the first contact between the propellants.

3. The third step corresponds to the first visible sign of reaction between the propellants, typically a “cloud” of reaction vapors.

4. The fourth and final step corresponds to the first visible sign of ignition.

As shown in FIG. 8, typical ignition delay values obtained with drop test devices are much greater than those obtained with two-sprays or two-jets devices. This is caused from the slow reaction of the propellants from the relatively poor mixing of the propellants, thus creating undesirably high ignition delay values.

With the conventional two-jets apparatus, the mixing of the propellants is improved, but ignition is still delayed by the time required to transform the jets into droplets and the time for those droplets to impinge on each and react. However, as illustrated in FIG. 8, it was unexpectedly discovered that, in the case of device of the present invention (which utilizes two-sprays), ignition is not appreciably delayed by any physical process (such as jets breakup or droplet formation), and thus ignition is reached much faster than with any other device.

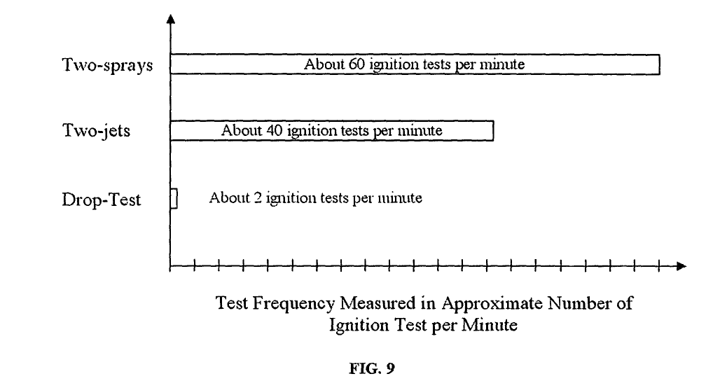

Further, as illustrated in FIG. 9 herein, the hypergolic fuel analytical device of the present invention allows a user thereof to increase the frequency of successful ignition tests, as compared to either conventional two-jets devices or conventional drop test devices. For example, typically, conventional drop test devices allow for two ignition tests per minute. A two-jets device, like the one presented by Spengler, is likely to allow for only up to about 30 ignition tests per minute, due to the larger volumes of propellant used per test, which lead to longer ignition delays/events. However, due to the superior mixing and the small volumes of propellants used for each test, the present device allows for up to 60 ignition tests per minute.

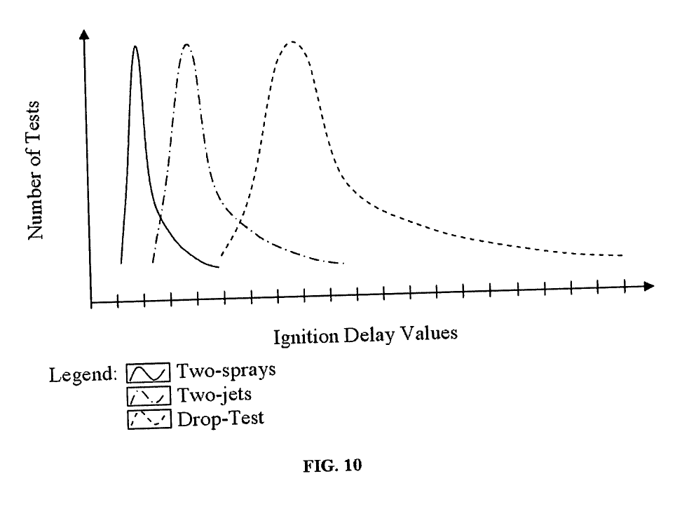

The present device also allows for better test repeatability than the conventional two-jets devices and conventional drop test devices. As shown in FIG. 10, ignition delay measurements usually follow a Gaussian distribution. The reported ignition delay value of a propellant combination corresponds to the smallest ignition delay value measured with a particular device. The width of the Gaussian distribution is an indicator of the repeatability of the test results.

Typically, the test results obtained with a conventional drop test device follow a relatively wide Gaussian distribution. The smallest ignition delay value is typically much lower than the distribution peak value. In contrast, ignition delay tests with a spray device, such as the present invention, and conventional two-jets devices, are typically more repeatable than those performed with drop test devices. The Gaussian distributions are usually centered around a value very close to the smallest measured ignition delay value. However, it was unexpectedly discovered that the superior mixing of the propellants due to the spraying of same from atomizing/spray nozzles on the device of the present invention substantially outperformed the conventional two-jets apparatus.

### TEST EXAMPLE #1

Approximately 0.75 ml of Block 0 (22% Manganese Acetate Tetrahydrate in Methanol solution (w/w)), a hypergolic fuel, was poured into the fuel supply means of the present device, and approximately 0.75 ml of 97% hydrogen peroxide, an oxidizer, was poured into the oxidizer supply means (the hypergolic fuel and oxidizer being collectively referred to as the “propellants”) of the hypergolic fuel analytical device of the first, second and fifth embodiment of the present invention. A compressed gas source containing argon was attached to the device. The inert gas (argon) pressure was set at 15 psig.

Thereafter, the device was activated so as to spray the propellants into the containment means and, simultaneously, record the ignition process with an ignition detection means (a high speed video camera).

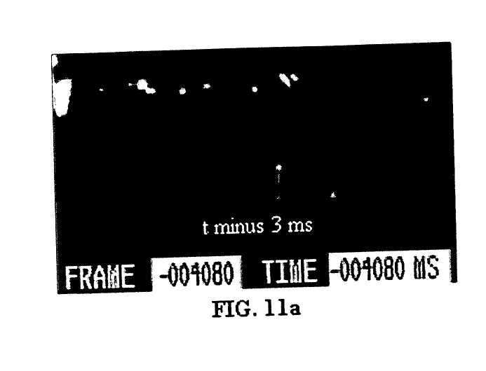

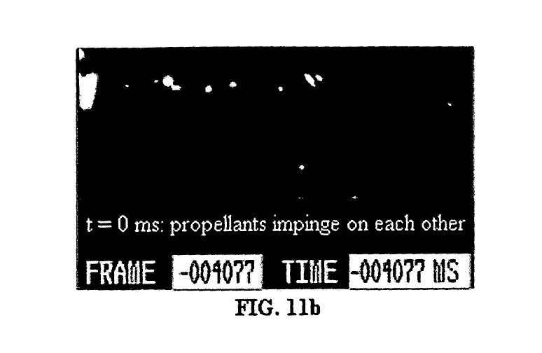

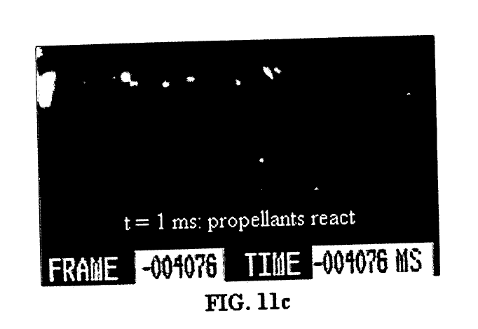

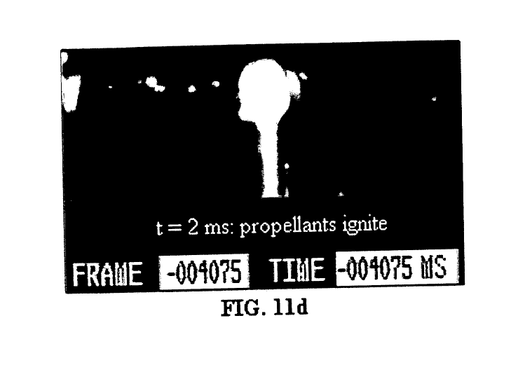

As shown in FIGS. 11a-11d, experimental results obtained using the device of the present invention, equipped with the spray nozzles and the flex line reservoir, demonstrated an ignition delay of approximately 2 ms (microseconds).

Note: The 0.75 ml of oxidizer and 0.75 ml of fuel allowed performance of approximately 10 ignition delay tests. Thus, each test required approximately 0.075 ml of fuel and oxidizer per ignition delay test.

### COMPARATIVE TEST EXAMPLE 1

Approximately 0.02 ml of 97% hydrogen peroxide, an oxidizer, was placed in the dropper portion of a conventional drop test device. Then, approximately 0.02 ml of BLOCK 0 (22% Manganese Acetate Tetrahydrate in Methanol solution (w/w)), a hypergolic fuel, was placed in the crucible of said drop test device. Thereafter, the BLOCK 0 was dropped into the oxidizer and, simultaneously, the ignition process was recorded with an ignition detection means (a high speed video camera).

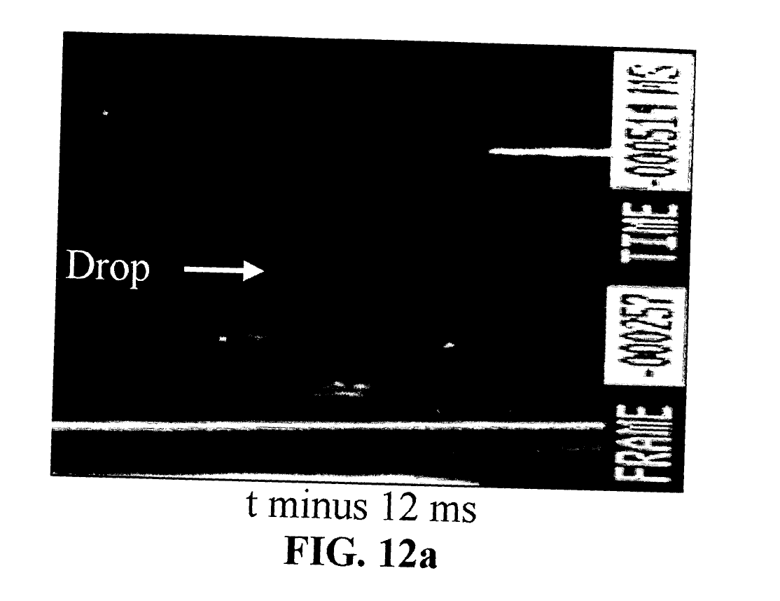

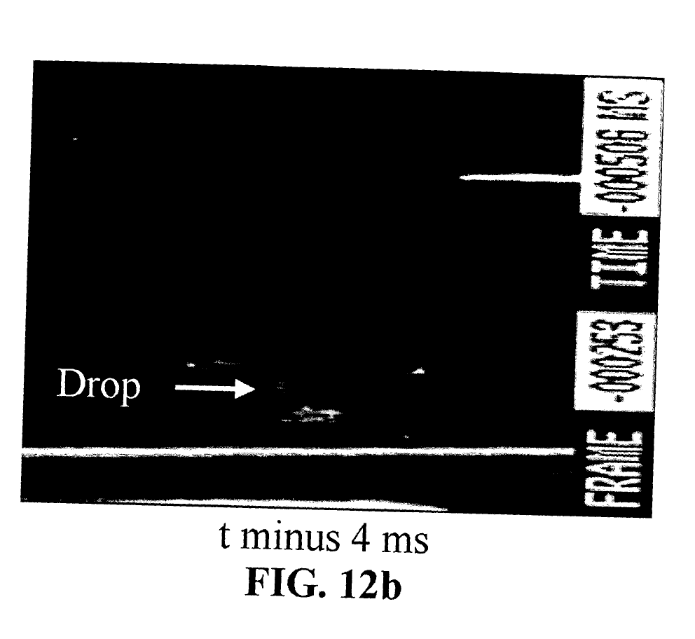

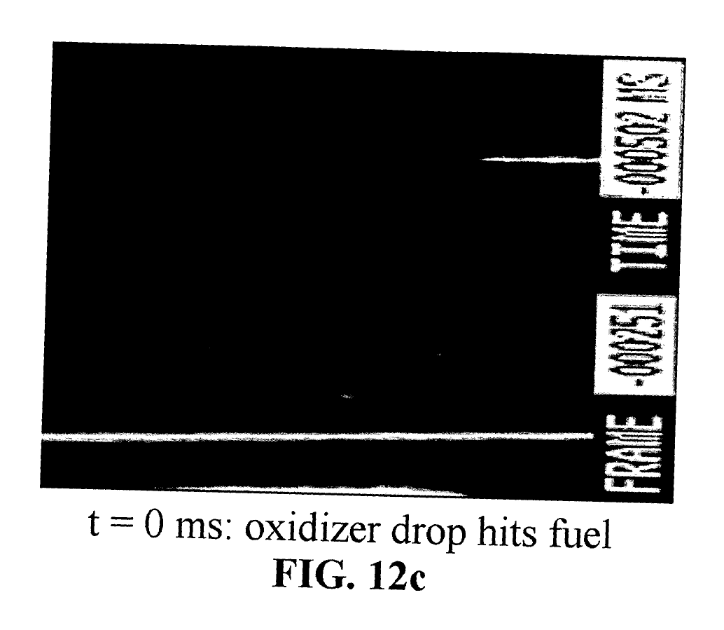

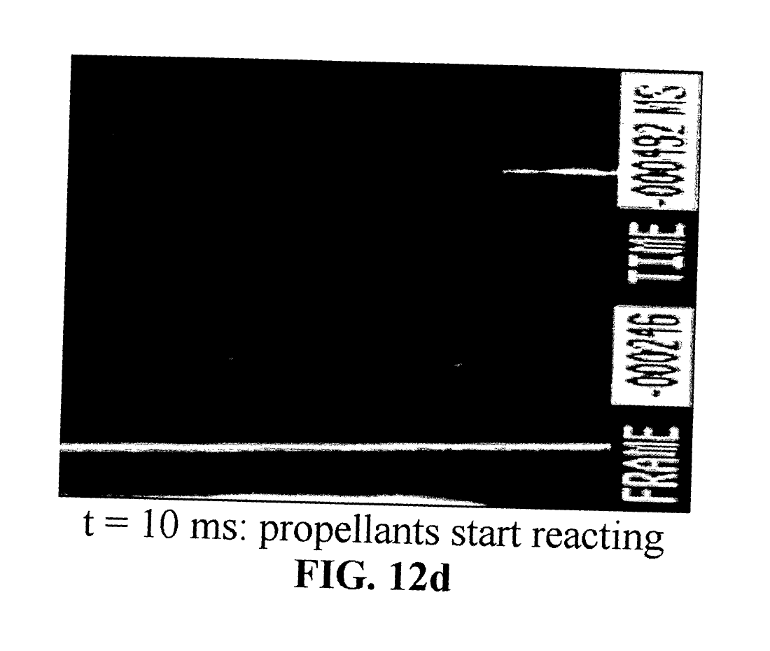

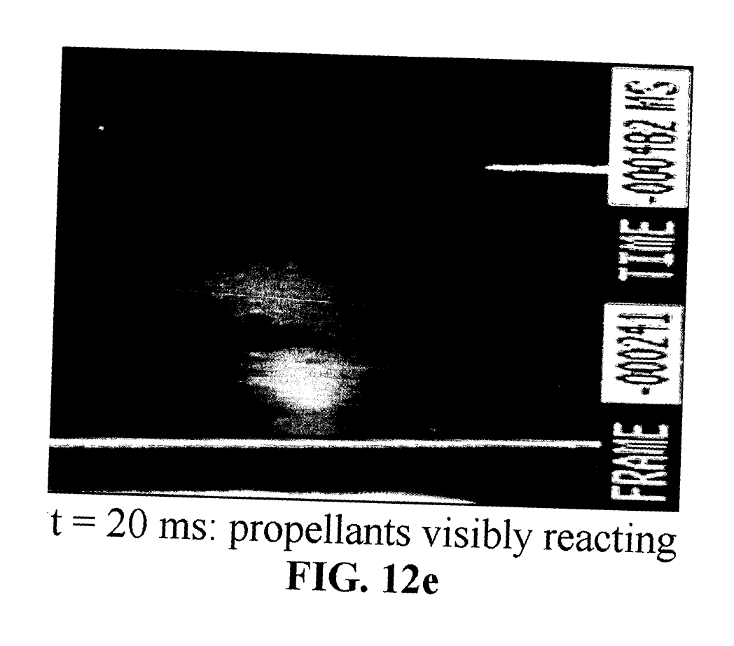

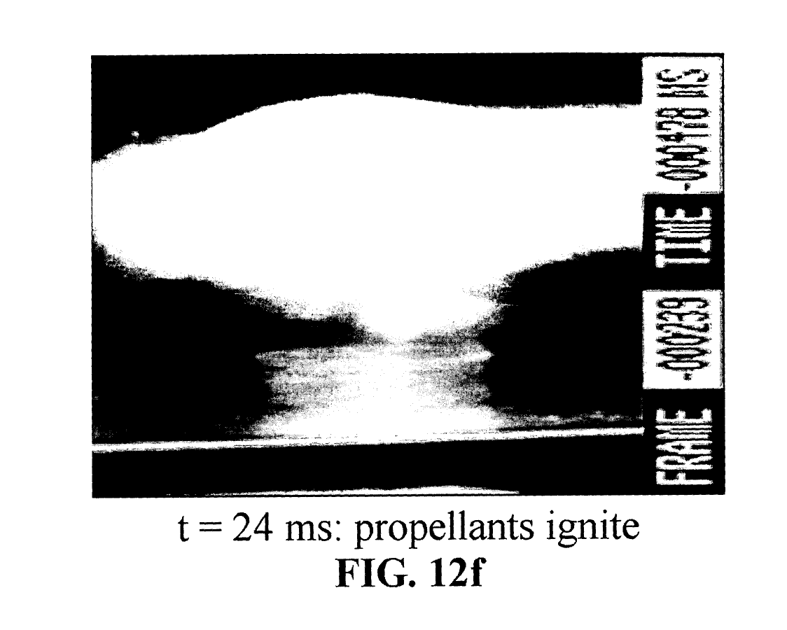

As shown in FIGS. 12a-12d, experimental ignition delay results obtained using the conventional drop test device demonstrated an ignition delay of approximately 24 ms (microseconds). Thus, it was experimentally observed that the device of the present invention allows for much more accurate recording of ignition delay values of hypergolic propellants.

Reference Numeral Identification List:

1—inert gas supply mean
13—first valve
15—second valve
16—third valve
21—supply line (to supply inert gas to first valve from inert gas supply means
25—reservoir
31—first gas lead
32—second gas lead
33—gas conduction means
35—oxidizer atomization means
36—fuel atomization means
40—ignition detection means
41—electrical lead
42—containment means
43—electrical lead
45—switching means
57—oxidizer atomization means adjustment apparatus
59—fuel atomization means adjustment apparatus
61—oxidizer supply means
63—fuel supply means
68—fuel supply line
71—oxidizer supply control means
72—fuel supply control means
79—predetermined intersecting spray pattern
80—fuel supply
82—oxidizer supply
84—variable valve
86—fast-action valve

1. A hypergolic fuel analytical device comprising:
a compressed inert gas supply means;
a first valve flowably connected to said inert gas means;
a reservoir flowably connected to said first valve;
a second valve flowably connected to said reservoir;
a switching means conductively connected to said first valve and said second valve;
a gas conduction means connected to said second valve, said gas conduction means having a first gas lead and a second gas lead;
an oxidizer atomization means connected to said first gas lead;
a fuel atomization means connected to said second gas lead;
an oxidizer supply means flowably connected to said oxidizer atomization means; and
a fuel supply means flowably connected to said fuel atomization means,
wherein fuel is fed from the fuel supply means into said fuel atomization means, oxidizer is fed from the oxidizer supply means into said oxidizer atomization means, the switching means activates the first valve so as to open said first valve and fill the reservoir with compressed inert gas, and the switching means then activates the second valve so as to open same and thus feed compressed inert gas from the second valve to the oxidizer atomization means and the fuel atomization means via the first gas lead and the second gas lead.

2. The hypergolic fuel analytical device of claim 1, further comprising:
a fuel atomization means adjustment apparatus adjustably connected with said fuel atomization means, and
an oxidizer atomization means adjustment apparatus adjustably connected with said oxidizer atomization means.

3. The hypergolic fuel analytical device of claim 1, further comprising an ignition detection means.

4. The hypergolic fuel analytical device of claim 1, further comprising a programmable computer control means electrically connected to the switching means, wherein testing operation of the device may be controlled thereby.

5. The hypergolic fuel analytical device of claim 1, further comprising a containment means adjacent the fuel atomization means and oxidizer atomization means, for containment of hypergolic reactions.

6. The hypergolic fuel analytical device of claim 1, further comprising:
a fuel supply control means flowably connected with the fuel supply means and the fuel atomization means, which controls the supply of fuel fed to the fuel atomization means; and
an oxidizer supply control means flowably connected with the oxidizer supply means, which controls the supply of fuel fed to the oxidizer atomization means.

7. The hypergolic fuel analytical device of claim 4, further comprising:
a fuel supply control means flowably connected with the fuel supply means and the fuel atomization means, which controls the supply of fuel fed to the fuel atomization means; and
an oxidizer supply control means flowably connected with the oxidizer supply means, which controls the supply of fuel fed to the oxidizer atomization means,
wherein the programmable computer control is in electrical connection with the fuel supply control means and oxidizer supply control means, so as to control the supply of fuel and oxidizer fed to the fuel atomization means and the oxidizer atomization means from the fuel supply means and oxidizer supply means.

8. The hypergolic fuel analytical device of claim 1, further comprising a third valve flowably connected to said second valve, and said gas conduction means connected to said third valve opposite said second valve.

9. A hypergolic fuel analytical device is provided comprising:
a compressed inert gas supply means;
a fast-action valve flowably connected to said inert gas means;
a switching means conductively connected to said fast-action;
a gas conduction means connected to said second valve, said gas conduction means having a first gas lead and a second gas lead;
an oxidizer atomization means connected to said first gas lead;
a fuel atomization means connected to said second gas lead;
an oxidizer supply means flowably connected to said oxidizer atomization means; and
a fuel supply means flowably connected to said fuel atomization means,
wherein fuel is fed from the fuel supply means into said fuel atomization means, oxidizer is fed from the oxidizer supply means into said oxidizer atomization means, the switching means activates the fast-action valve so as to open said fast-action valve and thus feed compressed inert gas from the fast-action valve to the oxidizer atomization means and the fuel atomization means via the first gas lead and the second gas lead.

10. The hypergolic fuel analytical device of claim 2, further comprising an ignition detection means.

11. The hypergolic fuel analytical device of claim 2, further comprising a programmable computer control means for electrically connected to the switching means, wherein testing operation of the device may be controlled thereby.

12. The hypergolic fuel analytical device of claim 2, further comprising a containment means adjacent the fuel atomization means and oxidizer atomization means, for containment of hypergolic reactions.

13. The hypergolic fuel analytical device of claim 2, further comprising:
a fuel supply control means in flowable connection with the fuel supply means and the fuel atomization means, which controls the supply of fuel fed to the fuel atomization means; and
an oxidizer supply control means in flowable connection with the oxidizer supply means, which controls the supply of fuel fed to the oxidizer atomization means.

14. The hypergolic fuel analytical device of claim 3, further comprising a programmable computer control means for electrically connected to the switching means, wherein testing operation of the device may be controlled thereby.

15. The hypergolic fuel analytical device of claim 4, further comprising a containment means adjacent the fuel atomization means and oxidizer atomization means, for containment of hypergolic reactions.

16. The hypergolic fuel analytical device of claim 5, further comprising:
a fuel supply control means in flowable connection with the fuel supply means and the fuel atomization means, which controls the supply of fuel fed to the fuel atomization means; and
an oxidizer supply control means in flowable connection with the oxidizer supply means, which controls the supply of fuel fed to the oxidizer atomization means.
